(19) United States
(12) Patent Application Publication
(10) Pub. No.: US 2021/0332201 A1
(43) Pub. Date: Oct. 28, 2021

(54) BIAXIALLY-STRETCHED POLYESTER FILM AND METHOD FOR PRODUCING THE SAME

(71) Applicant: NAN YA PLASTICS CORPORATION, Taipei (TW)

(72) Inventors: Wen-Cheng Yang, Taipei (TW); Te-Chao Liao, Taipei (TW); Chia-Yen Hsiao, Taipei (TW); Chun-Che Tsao, Taipei (TW)

(21) Appl. No.: 17/203,755

(22) Filed: Mar. 17, 2021

(30) Foreign Application Priority Data
Apr. 24, 2020 (TW) 109113714

(51) Int. Cl. C08J 5/18; C08K 7/18; C08K 9/06; C08K 3/36; C08K 3/30; C08K 3/22; C08L 67/02

(52) U.S. Cl. CPC C08J 5/18; C08K 7/18; C08K 9/06; C08K 3/36; C08K 3/30; C08K 3/22; C08J 2483/04; C08J 2367/02; C08K 2003/3045; C08K 2003/2227; C08L 2205/18; C08J 2425/06; C08J 2433/12; C08L 67/02

(57) ABSTRACT

A biaxially-stretched polyester film and a method for producing the same are provided. The biaxially-stretched polyester film includes a polyester resin matrix and spherical smoothing agents dispersed therein. The polyester resin matrix has a refractive index within a range from 1.5 to 1.7. The spherical smoothing agents each have a refractive index within a range from 1.3 to 1.9, a particle size within a range from 30 nm to 5 μm, and a circularity not less than 0.6. Based on 100 parts by weight of the biaxially-stretched polyester film, a content range of the polyester resin matrix is from 50 to 99.999 parts by weight, and a content range of the spherical smoothing agents is from 0.0001 to 10 parts by weight. The biaxially-stretched polyester film has a haze not greater than 2% and a transparency not less than 85%.

### CROSS-REFERENCE TO RELATED PATENT APPLICATION

This application claims the benefit of priority to Taiwan Patent Application No. 109113714, filed on Apr. 24, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester film and a method for producing the same, and more particularly to a biaxially-stretched polyester film and a method for producing the same.

### BACKGROUND OF THE DISCLOSURE

Conventional biaxially-stretched polyester films are used in various applications, such as construction and insulation papers for automobiles, as well as surface protective films for displays, touch panels, and 3C components. In addition, in a conventional production process for the biaxially-stretched polyester film, the biaxially-stretched polyester film is endowed with high transparency, and smoothing agents are added to facilitate the producing process.

However, in the conventional production process for the biaxially-stretched polyester film having high transparency, film surface defects such as surface abrasion and surface unevenness occur easily. Therefore, it is difficult for the conventional biaxially-stretched polyester film having high transparency to maintain high transparency and quality of appearance.

### SUMMARY OF THE DISCLOSURE

In response to the above-referenced technical inadequacies, the present disclosure provides a biaxially-stretched polyester film and a method for producing the same, which can effectively improve on issues associated with a conventional biaxially-stretched polyester film and a method for producing the same.

In one aspect, the present disclosure provides a biaxially-stretched polyester film. The biaxially-stretched polyester film includes a polyester resin matrix and a plurality of spherical smoothing agents. The polyester resin matrix has a refractive index within a range from 1.5 to 1.7. The spherical smoothing agents are dispersed in the polyester resin matrix. Each of the spherical smoothing agents has a refractive index with a range from 1.3 to 1.9, a particle size within a range from 30 nm to 5 μm, and a circularity greater than or equal to 0.6. Based on 100 parts by weight of the biaxially-stretched polyester film, a content range of the polyester resin matrix is from 50 to 99.999 parts by weight, and a content range of the spherical smoothing agents is from 0.0001 to 10 parts by weight. The biaxially-stretched polyester film is formed through a biaxial stretching process, and the biaxially-stretched polyester film has a haze lower than or equal to 2% and a transparency greater than or equal to 85%.

In another aspect, the present disclosure provides a method for producing a biaxially-stretched polyester film. The method for producing the biaxially-stretched polyester film includes: providing a polyester resin matrix having a refractive index within a range from 1.5 to 1.7; providing a plurality of spherical smoothing agents, each of the spherical smoothing agents having a refractive index within a range from 1.3 to 1.9, a particle size within a range from 30 nm to 5 μm, and a circularity greater than or equal to 0.6; and mixing and then melt-extruding the polyester resin matrix and the spherical smooth agents, so as to form a biaxially-stretched polyester film through a biaxial stretching process. Based on 100 parts by weight of the biaxially-stretched polyester film, a content range of the polyester resin matrix is from 50 to 99.999 parts by weight, and a content range of the spherical smoothing agents is from 0.0001 to 10 parts by weight. After the biaxial stretching process, the biaxially-stretched polyester film has a haze lower than or equal to 2% and a transparency greater than or equal to 85%.

Therefore, the transparency of the biaxially-stretched polyester film can be increased (greater than or equal to 85%), and the haze of the biaxially-stretched polyester film can be decreased (less than or equal to 2%) through the technical solutions of “the polyester resin matrix has the refractive index within a range from 1.5 to 1.7”, “each of the spherical smoothing agents has a refractive index within a range from 1.3 to 1.9, a particle size within a range from 30 nm to 5 μm, and a circularity greater than or equal to 0.6”, and “based on 100 parts by weight of the biaxially-stretched polyester film, a content range of the polyester resin matrix is from 50 to 99.999 parts by weight, and a content range of the spherical smoothing agents is from 0.0001 to 10 parts by weight”. Accordingly, the biaxially-stretched polyester film can be applied to various fields and exert its excellent properties.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a sectional view of a biaxially-stretched polyester film according to one embodiment of the present disclosure;

FIG. 2 is a sectional view showing a plurality of spherical smoothing agents being added to two outer surface layers according to one embodiment of the present disclosure; and

FIG. 3 is a flowchart of a method for producing a biaxially-stretched polyester film according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Biaxially-Stretched Polyester Film

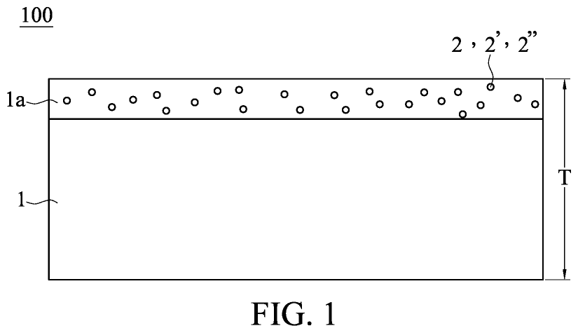

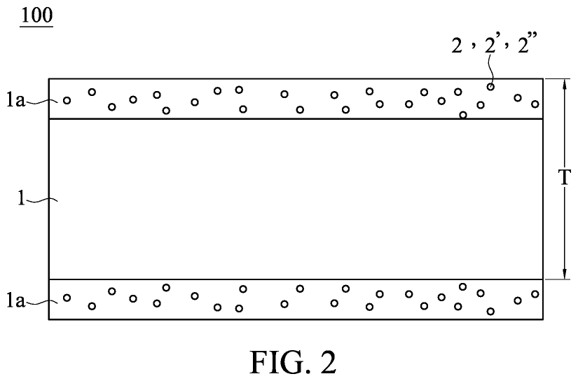

Referring to FIG. 1 and FIG. 2, the present disclosure provides a biaxially-stretched polyester film 100. The biaxially-stretched polyester film 100 includes a polyester resin matrix 1 and a plurality of spherical smoothing agents 2 dispersed in the polyester resin matrix 1. The biaxially-stretched polyester film 100 is used in various applications, such as construction and insulation papers for automobiles, as well as surface protective films for displays, touch panels, and 3C components, but the present disclosure is not limited thereto. In the present embodiment, the biaxially-stretched polyester film 100 is exemplified in a two-layered form and a three-layered form. However, the biaxially-stretched polyester film 100 can also be in a one-layered form, and the present disclosure is not limited thereto.

In terms of a thickness T of the biaxially-stretched polyester film 100, the biaxially-stretched polyester film 100 has the thickness T that is within a range from 12 μm to 400 μm. If the thickness T of the biaxially-stretched polyester film 100 is greater than an upper limit (e.g., greater than 400 μm), the transparency of the biaxially-stretched polyester film 100 may decrease or the haze of the biaxially-stretched polyester film 100 may increase, thereby affecting the property and the appearance quality of the biaxially-stretched polyester film 100.

The material of the polyester resin base layer 1 is a polymer prepared from a condensation reaction between a dibasic acid and a diol or a derivative thereof. That is, the material of the polyester resin matrix 1 is mainly a polyester material. Preferably, the polyester material is polyethylene terephthalate (PET) or polyethylene naphthalate (PEN), but the present disclosure is not limited thereto. In addition, the polyester resin matrix 1 has a refractive index that is within a range from 1.5 to 1.7.

It is worth mentioning that the above-mentioned dibasic acid as a raw material that forms the polyester material is at least one selected from the group consisting of terephthalic acid, isophthalic acid, 1,5-naphthalene dicarboxylic acid, 2,6-naphthalene dicarboxylic acid, 1,4-naphthalene dicarboxylic acid, dibenzoic acid, diphenylethane dicarboxylic acid, diphenylphosphonium dicarboxylic acid, indole-2,6-dicarboxylic acid, 1,3-cyclopentanedicarboxylic acid, 1,3-cyclohexanedicarboxylic acid, 1,4-cyclohexanedicarboxylic acid, malonic acid, dimethylmalonic acid, succinic acid, diethyl 3,3-succinate, glutaric acid, 2,2-dimethylglutaric acid, adipic acid, 2-methyladipate, trimethyl adipate, pimelic acid, azelaic acid, sebasic acid, suberic acid, and dodecanedioic acid.

In addition, the above-mentioned raw material diol that forms the polyester material is at least one selected from the group consisting of ethylene glycol, propylene glycol, hexamethylene glycol, neopentyl glycol, 1,2-cyclohexanedimethanol, 1,4-cyclohexanedimethanol, 1,10-decanediol, 1,3-propanediol, 1,4-butanediol, 1,5-pentanediol, 1,6-hexanediol, and 2,2-bis(4-hydroxyphenyl)propane, and bis(4-hydroxyphenyl)anthracene.

Each of the spherical smoothing agents 2 has a refractive index within a range from 1.3 to 1.9, a particle size within a range from 30 nm to 5 μm, and a circularity greater than or equal to 0.6. In addition, a surface of each of the spherical smoothing agents 2 is covered with a siloxane compound or modified with siloxy to be in contact with the polyester resin matrix 1.

Further, the spherical smoothing agents 2 are dispersed in at least one outer surface layer 1a of the biaxially-stretched polyester film 100, and a thickness of the at least one outer surface layer 1a is within 3% to 20% of an overall thickness T of the biaxially-stretched polyester film 100. More specifically, in the present embodiment, the thickness T (i.e., the overall thickness T) of the biaxially-stretched polyester film 100 is within a range from 12 μm to 400 μm, and it can be inferred that the thickness of the outer surface layer 1a is within a range from 0.36 μm to 8 μm.

It is worth mentioning that, the spherical smoothing agents 2 can function as long as the spherical smoothing agents 2 are dispersed in the at least one outer surface layer 1a of the biaxially-stretched polyester film 100. Other smoothing agents that are evenly dispersed in the biaxially-stretched polyester film 100 or other smoothing agents that are not dispersed only in the outer surface layer 1a (e.g., a thickness of the smoothing agents occupied in the biaxially-stretched polyester film being greater than 20% of the overall thickness of the biaxially-stretched polyester film) are not suitable to be compared to the spherical smoothing agents 2 in the present disclosure.

It should be noted that, in a biaxial stretching process for producing the biaxially-stretched polyester film 100, a low affinity between each of the spherical smoothing agents 2 and the polyester resin matrix 1 may lead to creation of a fissure. The fissure may cause the haze of the biaxially-stretched polyester film 100 to increase or the transparency of the biaxially-stretched polyester film 100 to decrease, thereby affecting the property and the appearance quality of the biaxially-stretched polyester film 100. Therefore, since the surface of each of the spherical smoothing agents 2 is covered with the siloxane compound or modified with siloxy, the affinity between each of the spherical smoothing agents 2 and the polyester resin matrix 1 is increased, thereby preventing fissures from forming and enabling the spherical smoothing agents 2 to be more evenly dispersed in the outer surface layer 1a of the polyester resin matrix 1.

In terms of the particle size, if the particle size of each of the spherical smoothing agents 2 is greater than an upper limit (e.g., greater than 5 μm), the polyester resin matrix 1 may have gaps (or voids) that are too many and too large, or a film surface of the biaxially-stretched polyester 100 may be uneven, thereby affecting the transparency, the haze, and the appearance quality of the biaxially-stretched polyester 100. In contrast, if the particle size of each of the spherical smoothing agents 2 is less than a lower limit (e.g., less than 30 nm), it is difficult for the spherical smoothing agents 2 to provide their functions. In other words, without causing gaps that are too many and too large to form or without causing a film surface defect of the biaxially-stretched polyester 100 (e.g., the film surface being uneven), the spherical smoothing agents 2 should be added in an amount sufficient for the spherical smoothing agents 2 to provide their functions and not affect the property and the appearance quality of the biaxially-stretched polyester 100.

In terms of the circularity, each of the spherical smoothing agents 2 has the circularity that is greater than or equal to 0.6. Preferably, the circularity of each of the spherical smoothing agents 2 is greater than or equal to 0.8. The greater the circularity of each of the spherical smoothing agents 2 is, the closer the shape of each of the spherical smoothing agents 2 is to an ideal spherical shape. In contrast, the lower the circularity of each of the spherical smoothing agents 2 is, the more likely it is for a surface of each of the spherical smoothing agents 2 to have protrusions, dents, or an irregular shape, such that the shape of each of the spherical smoothing agents 2 does not resemble the ideal spherical shape. More specifically, if the circularity of each of the spherical smoothing agents 2 is too low (e.g., lower than 0.6), the irregular surface or the protrusions of each of the spherical smoothing agents 2 may cause the gaps of the polyester resin matrix 1 or cause the film surface defect of the biaxially-stretched polyester film 100, thereby affecting the transparency, the haze, the property, and the appearance quality of the biaxially-stretched polyester film 100.

In terms of the refractive index, each of the spherical smoothing agents 2 has the refractive index that is within a range from 1.3 to 1.9. Preferably, the refractive index of each of the spherical smoothing agents 2 is within a range from 1.55 to 1.65, and an absolute value of a difference between the refractive index of the polyester resin matrix 1 and the refractive index of each of the spherical smoothing agents 2 is less than or equal to 1.5. If the absolute value of the difference between the refractive index of the polyester resin matrix 1 and the refractive index of each of the spherical smoothing agents 2 is greater than 1.5, a difference between a refractive angle of a light beam passing through the polyester resin matrix 1 and a refractive angle of a light beam passing through each of the spherical smoothing agents 2 will be too large, thereby decreasing the transparency of the biaxially-stretched polyester film 100 and increasing the haze of the biaxially-stretched polyester film 100.

In terms of the content range, in the present embodiment, based on 100 parts by weight of the biaxially-stretched polyester film 100, a content range of the spherical smoothing agents 2 is from 0.0001 to 10 parts by weight. Preferably, based on 100 parts by weight of the biaxially-stretched polyester film 100, the content range of the spherical smoothing agents 2 is from 0.0002 to 5 parts by weight. If the content of the spherical smoothing agents 2 is lower than a lower limit of the content range (e.g., lower than 0.0001 parts by weight), the spherical smoothing agents 2 may not provide their intended functions. If the content of the spherical smoothing agents 2 is greater than an upper limit of the content range (e.g., greater than 10 parts by weight), the excessive spherical smoothing agents 2 may increase the probability of the gaps forming or the probability of the film surface defect, and may also cause the transparency of the biaxially-stretched polyester film 100 to be too low and the haze thereof to be too high.

According to the polyester resin matrix 1 and the spherical smoothing agents 2 mentioned above, the biaxially-stretched polyester film 100 has the haze less than or equal to 2%, the transparency greater than or equal to 85%, a surface roughness (Ra) within a range from 0.005 to 0.1, and a coefficient of friction within a range from 0.1 to 0.6. Preferably, the haze is within a range from 0.05% to 2%, and the transparency is greater than or equal to 88%.

It should be noted that the coefficient of friction mentioned herein refers to the coefficient of friction in the material of the biaxially-stretched polyester film 100 itself. If the surface roughness of the biaxially-stretched polyester film 100 is greater than 0.1 or the coefficient of friction is greater than 0.6, the biaxially-stretched polyester film 100 may have abrasions or scratches when being produced or used, thereby affecting the property and the appearance quality of the biaxially-stretched polyester film 100 (e.g., the haze of the biaxially-stretched polyester film 100 increases and the transparency thereof decreases due to the abrasions or the scratches).

In terms of material selection of the spherical smoothing agents 2, in the present embodiment, each of the spherical smoothing agents 2 can be further limited as an inorganic spherical particle 2′, and a material of each of the inorganic spherical particles 2′ is at least one selected from the group consisting of silica, alumina, barium sulfate, calcium sulfate, molybdenum disulfide, and aluminosilicate. In addition, in an embodiment of the present disclosure, a hardness of each of the inorganic spherical particles 2′ is greater than or equal to 3, so that the circularity of each of the inorganic spherical particles 2′ does not easily decrease due to deformation in the biaxial stretching process.

In an embodiment of the present disclosure, each of the spherical smoothing agents 2 can also be an organic spherical particle 2″, and each of the organic spherical particles 2″ is at least one selected from the group consisting of polystyrene, polymethyl methacrylate, polyurethane resins, amino alkyd resins, acrylic resins, and organic silicone resins.

### Method for Producing Biaxially-Stretched Polyester Film

While the description above is related to the biaxially-stretched polyester film 100, a method for producing the biaxially-stretched polyester film will be described below according to an embodiment of the present disclosure.

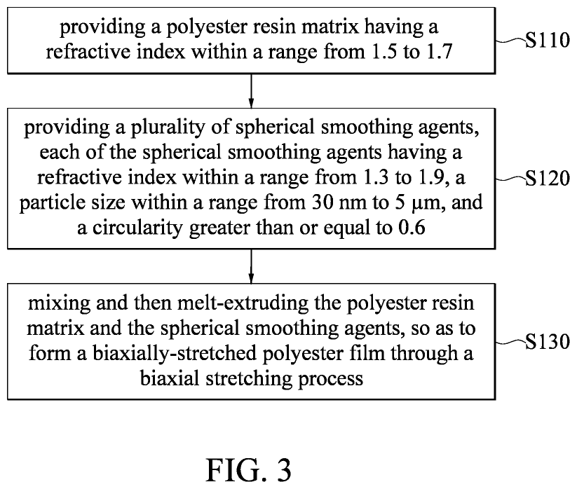

Referring to FIG. 3, the present embodiment provides the method for producing the biaxially-stretched polyester film. The method for producing the biaxially-stretched polyester film includes a step S110, a step S120, and a step S130. It should be noted that the order of the steps described in the present embodiment and the actual operation method may be adjusted according to practical requirements, and the present disclosure is not limited thereto. Further, production of the biaxially-stretched polyester film 100 is not limited to the method provided in the present embodiment.

The step S110 is implemented by providing a polyester resin matrix 1 having a refractive index within a range from 1.5 to 1.7.

The step S120 is implemented by providing a plurality of spherical smoothing agents 2 each having a refractive index within a range from 1.3 to 1.9, a particle size within a range from 30 nm to 5 μm, and a circularity greater than or equal to 0.6.

The step S130 is implemented by mixing the polyester resin matrix 1 and the spherical smoothing agents 2, performing a melting and extruding process, and forming a biaxially-stretched polyester film 100 through a biaxial stretching process.

Further, the biaxial stretching method may be performed through, for example, a longitudinal uniaxial stretching method, a transverse uniaxial stretching method, a vertical axis-horizontal axis sequential biaxial stretching method, or a vertical axis-horizontal axis simultaneous biaxial stretching method, and the present disclosure is not limited thereto. For example, in the above biaxial stretching method, an un-stretched polyester film is preheated at an extension temperature (e.g., within a range from 50° C. to 150° C.). Then, a stretching process is carried out in a width direction of the un-stretched polyester film according to different elongation ratios, and a stretching process is further carried out in a length direction of the un-stretched polyester film. The elongation ratios in the width direction and the length direction can be changed according to practical requirements, and the present disclosure is not limited thereto.

Based on 100 parts by weight of the biaxially-stretched polyester film 100, the content range of the polyester resin matrix is from 50 to 99.999 parts by weight, and the content range of the spherical smoothing agents is from 0.0001 to 10 parts by weight.

After performing the biaxial stretching method, the biaxially-stretched polyester film 100 has the haze less than or equal to 2%, and a transparency greater than or equal to 85%.

The spherical smoothing agents 2 are dispersed in at least one outer surface layer 1a of the biaxially-stretched polyester film 100, and the thickness of the at least one outer surface layer 1a is within 3% to 20% of the overall thickness T of the biaxially-stretched polyester film 100.

### Experimental Results

Hereinafter, exemplary examples 1 to 3 and comparative examples 1 to 3 will be described in detail. However, the exemplary examples are only used to aid in understanding of the present disclosure, and the scope of the present disclosure is not limited to these examples.

The content of each component, the refractive index, the particle size, the circularity, the haze, the transparency, the surface roughness, and the coefficient of friction of the biaxially-stretched polyester film 100 in each of the exemplary examples 1 to 3 and the comparative examples 1 to 3 are shown in Table 1 below, and the relevant test methods are described below.

The roughness test includes: using KOSAKA ET4000A surface roughness analyzer to measure a surface state of the biaxially-stretched polyester film 100.

The coefficient of friction test includes: overlapping two biaxially-stretched polyester films 100, and using A&B CFT400 to measure the coefficient of friction.

The transparency test includes: using a haze meter (TC-H produced by Tokyo Denshoku Co., Ltd.) to measure the transparency of the biaxially-stretched polyester film 100.

The haze test includes: using the haze meter (TC-H produced by Tokyo Denshoku Co., Ltd.) to measure the haze of the biaxially-stretched polyester film 100.

Table 1 shows the content of each component and test results of the exemplary and comparative examples.

TABLE 1

| | | exem- | exem- | exem- |
|---|---|---|---|---|
| | | plary | plary | plary |
| Items | | example 1 | example 2 | example 3 |
| Parameter | content of polyester | 99.985 | 99.92 | 99.994 |
| of each | resin matrix (wt %) | | | |
| component | content of spherical | 0.015 | 0.080 | 0.006 |
| | smoothing agents | | | |
| | (wt %) | | | |
| | refractive index of | 1.57 | 1.575 | 1.575 |
| | polyester resin | | | |
| | matrix | | | |
| | refractive index of | 1.46 | 1.62 | 1.64 |
| | spherical smoothing | | | |
| | agent | | | |
| | thickness of biaxially- | 16 | 30 | 200 |
| | stretched polyester | | | |
| | film (μm) | | | |
| | particle size of | 0.5 | 0.3 | 1.0 |
| | spherical smoothing | | | |
| | agent (μm) | | | |
| | circularity of | 0.9 | 0.7 | 0.8 |
| | spherical smoothing | | | |
| | agent | | | |
| Test | haze of biaxially- | 0.6 | 0.9 | 0.8 |
| results | stretched polyester | | | |
| | film (%) | | | |
| | transparency of | 89.9 | 90.2 | 88.7 |
| | biaxially-stretched | | | |
| | polyester film (%) | | | |
| | surface roughness of | 0.05 | 0.03 | 0.08 |
| | biaxially-stretched | | | |
| | polyester film | | | |
| | coefficient of friction | 0.37 | 0.42 | 0.36 |
| | of biaxially-stretched | | | |
| | polyester film | | | |
| | | compar- | compar- | compar- |
| | | ative | ative | ative |
| Items | | example 1 | example 2 | example 3 |
| Parameter | content of polyester | 99.925 | 99.995 | 99.68 |
| of each | resin matrix (wt %) | | | |
| component | content of spherical | 0.075 | 0.005 | 0.32 |
| | smoothing agents | | | |
| | (wt %) | | | |
| | refractive index of | 1.57 | 1.575 | 1.575 |
| | polyester resin | | | |
| | matrix | | | |
| | refractive index of | 1.46 | 1.62 | 1.64 |
| | spherical smoothing | | | |
| | agent | | | |
| | thickness of biaxially- | 32 | 30 | 180 |
| | stretched polyester | | | |
| | film (μm) | | | |
| | particle size of | 0.5 | 0.1 | 1.2 |
| | spherical smoothing | | | |
| | agent (μm) | | | |
| | circularity of | 0.9 | 0.6 | 0.8 |
| | spherical smoothing | | | |
| | agent | | | |
| Test | haze of biaxially- | 5.6 | 0.3 | 12 |
| results | stretched polyester | | | |
| | film (%) | | | |
| | transparency of | 88.6 | 90.6 | 86.4 |
| | biaxially-stretched | | | |
| | polyester film (%) | | | |
| | surface roughness of | 0.07 | 0.01 | 0.12 |
| | biaxially-stretched | | | |
| | polyester film | | | |
| | coefficient of friction | 0.32 | 0.62 | 0.27 |
| | of biaxially-stretched | | | |
| | polyester film | | | |

### Discussion of Test Results

According to the content of each the component and process parameters of the exemplary and comparative examples as shown in Table 1, since the absolute value of the difference between the refractive index of the polyester resin matrix 1 and the refractive index of each of the spherical smoothing agents 2 is less than or equal to 1.5, the particle size of each of the spherical smoothing agents 2 is within a range from 30 nm to 5 μm, and the circularity of each of the spherical smoothing agents 2 is greater than or equal to 0.6, the biaxially-stretched polyester films 100 of the exemplary examples 1 to 3 have the haze less than or equal to 2%, the transparency greater than or equal to 85%, the surface roughness within a range from 0.005 to 0.1, and the coefficient of friction within a range from 0.1 to 0.6.

The particle sizes of the spherical smoothing agents 2 of the exemplary examples 1 to 3 are relatively less than those of the comparative examples 1 to 3, and the circularities of the spherical smoothing agents 2 of the exemplary examples 1 to 3 are relatively greater than those of the comparative examples 1 to 3. Therefore, the biaxially-stretched polyester films 100 of the exemplary examples 1 to 3 have less haze, less surface roughness, less coefficient of friction, and greater transparency, as compared with the comparative examples 1 to 3.

As shown in the exemplary example 2 and the comparative example 1, since the absolute value of the difference between the refractive index of the polyester resin matrix 1 and the refractive index of each of the spherical smoothing agents 2 in the comparative example 1 is greater, the haze and the surface roughness of the biaxially-stretched polyester film 100 in the exemplary example 2 are lower, and the transparency thereof is higher.

### Advantageous Effect

In conclusion, the transparency of the biaxially-stretched polyester film can be increased (greater than or equal to 85%), and the haze of the biaxially-stretched polyester film can be decreased (less than or equal to 2%) through the technical solutions of “the polyester resin matrix has the refractive index within a range from 1.5 to 1.7”, “each of the spherical smoothing agents has a refractive index within a range from 1.3 to 1.9, a particle size within a range from 30 nm to 5 μm, and a circularity greater than or equal to 0.6”, and “based on 100 parts by weight of the biaxially-stretched polyester film, a content range of the polyester resin matrix is from 50 to 99.999 parts by weight, and a content range of the spherical smoothing agents is from 0.0001 to 10 parts by weight”. Accordingly, the biaxially-stretched polyester film can be applied to various fields and exert its excellent properties.

Further, since each of the spherical smoothing agents has a relatively high circularity (e.g., greater than or equal to 0.6, preferably greater than or equal to 0.8), the irregular surface or the protrusions of each of the spherical smoothing agents can be prevented from causing the gaps of the polyester resin matrix from forming or cause the film surface defect of the biaxially-stretched polyester film, thereby affecting the transparency, the haze, the property, and the appearance quality of the biaxially-stretched polyester film.

Since the absolute value of a difference between the refractive index of the polyester resin matrix and the refractive index of each of the spherical smoothing agents is less than or equal to 1.5, the difference between the refractive angle of the light beam passing through the polyester resin matrix and the refractive angle of the light beam passing through each of the spherical smoothing agents can avoid being too large, thereby decreasing the transparency and increasing the haze of the biaxially-stretched polyester film.

Since the surface of each of the spherical smoothing agents is covered with the siloxane compound or modified with siloxy, the affinity between each of the spherical smoothing agents and the polyester resin matrix is increased. Accordingly, each of the spherical smoothing agents can be better dispersed in the outer surface layer of the polyester resin matrix, and the gaps can be decreased or prevented.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A biaxially-stretched polyester film, comprising:
a polyester resin matrix having a refractive index within a range from 1.5 to 1.7; and
a plurality of spherical smoothing agents dispersed in the polyester resin matrix, wherein each of the spherical smoothing agents has a refractive index within a range from 1.3 to 1.9, a particle size within a range from 30 nm to 5 μm, and a circularity greater than or equal to 0.6,
wherein, based on 100 parts by weight of the biaxially-stretched polyester film, a content range of the polyester resin matrix is from 50 to 99.999 parts by weight, and a content range of the spherical smoothing agents is from 0.0001 to 10 parts by weight, and
wherein the biaxially-stretched polyester film is formed through a biaxial stretching process, and the biaxially-stretched polyester film has a haze lower than or equal to 2% and a transparency greater than or equal to 85%.

2. The biaxially-stretched polyester film according to claim 1, wherein the spherical smoothing agents are dispersed in at least one outer surface layer of the biaxially-stretched polyester film, and a thickness of the at least one outer surface layer is from 3% to 20% of an overall thickness of the biaxially-stretched polyester film.

3. The biaxially-stretched polyester film according to claim 1, wherein a surface of each of the spherical smoothing agents is covered with a siloxane compound or modified with siloxy to be in contact with the polyester resin matrix.

4. The biaxially-stretched polyester film according to claim 1, wherein an absolute value of a difference between the refractive index of the polyester resin matrix and the refractive index of each of the spherical smoothing agents is less than or equal to 1.5.

5. The biaxially-stretched polyester film according to claim 4, wherein, based on 100 parts by weight of the biaxially-stretched polyester film, the content range of the spherical smoothing agents is from 0.0002 to 5 parts by weight.

6. The biaxially-stretched polyester film according to claim 1, wherein the biaxially-stretched polyester film has a thickness within a range from 12 μm to 400 μm, a surface roughness (Ra) within a range from 0.005 to 0.1, a coefficient of friction within a range from 0.1 to 0.6, the haze within a range from 0.05% to 2%, and the transparency equal to or greater than 88%.

7. The biaxially-stretched polyester film according to claim 1, wherein each of the spherical smoothing agents is an inorganic spherical particle, and the inorganic spherical particle is at least one selected from the group consisting of silica, alumina, barium sulfate, calcium sulfate, and aluminosilicate.

8. The biaxially-stretched polyester film according to claim 1, wherein each of the spherical smoothing agents is an organic spherical particle, and the organic spherical particle is at least one selected from the group consisting of polystyrene, polymethyl methacrylate, and organic silicone resin.

9. A method for producing a biaxially-stretched polyester film, the method comprising:
providing a polyester resin matrix having a refractive index within a range from 1.5 to 1.7;
providing a plurality of spherical smoothing agents, each of the spherical smoothing agents having a refractive index within a range from 1.3 to 1.9, a particle size within a range from 30 nm to 5 μm, and a circularity greater than or equal to 0.6; and
mixing and then melt-extruding the polyester resin matrix and the spherical smoothing agents, so as to form the biaxially-stretched polyester film through a biaxial stretching process,
wherein, based on 100 parts by weight of the biaxially-stretched polyester film, a content range of the polyester resin matrix is from 50 to 99.999 parts by weight, and a content range of the spherical smoothing agents is from 0.0001 to 10 parts by weight, and
wherein, after the biaxial stretching process, the biaxially-stretched polyester film has a haze lower than or equal to 2% and a transparency greater than or equal to 85%.

10. The method according to claim 9, wherein the spherical smoothing agents are dispersed in at least one outer surface layer of the biaxially-stretched polyester film, and a thickness of the at least one outer surface layer is within a range from 3% to 20% of an overall thickness of the biaxially-stretched polyester film.
